(19) United States
(12) Patent Application Publication
(10) Pub. No.: US 2005/0263500 A1
(43) Pub. Date: Dec. 1, 2005

(54) Laser or laser/arc hybrid welding process with formation of a plasma on the backside

(76) Inventors: Francis Briand, Paris (FR); Philippe Lefebvre, Meulan (FR); Olivier Dubet, Franconville (FR)

Correspondence Address: Linda K. Russell;Suite 1800, 2700 Post Oak Blvd., Houston, TX, 77056, US

(21) Appl. No.: 11/133,995

(22) Filed: May 20, 2005

(30) Foreign Application Priority Data
May 26, 2004 (FR) 0451042

(51) Int. Cl. B23K 26/20

(52) U.S. Cl. 219/121.64; 219/121.84

(57) ABSTRACT

A method for welding metal work pieces with a CO₂ type laser. A first shielding gas is used on the topside of the work piece, a second shielding gas is used on the backside of the work piece. The first and the second shielding gases have different compositions. A full penetration weld joint is produced by at least a laser beam which is delivered from the topside of the work piece. A plasma, which contributes to the production of the welded joint, is created in the second plasma gas.

The invention relates to a laser welding or laser/arc hybrid welding process for one or more metal workpieces, in particular flat panels intended for use in shipyards, longitudinal edges of pipes or pipelines, or else the manufacture of tailored blanks that can be used in the automobile industry.

Laser beam welding is a very effective welding process which, compared with other more conventional processes, such as arc welding, allows very high welding speeds and very large penetration depths to be achieved.

This performance is obtained thanks to the high power densities involved when focusing the laser beam onto the workpiece or workpieces to be welded using one or more mirrors or lenses.

This is because such high laser power densities cause, on the surface of the workpiece (or workpieces) very substantial evaporation which, on relaxing towards the outside, induces progressive hollowing, called “rocket effect”, of the weld pool and results in the appearance, in the thickness of the plate, of a vapour capillary or “keyhole”. This capillary allows energy to be deposited directly in the core of the plate, as opposed to a more conventional process in which the melting is carried out mainly by thermal propagation.

Typically, a capillary consists of a mixture of metal vapours and metal vapour plasma, the particular feature of which is that it absorbs the laser beam and therefore traps the energy within the actual capillary.

When the capillary is emerging, the welding is referred to as emerging welding, that is to say it passes completely through the plate to be welded. This process is accompanied by a loss of energy on the backside, since all the power of the laser beam is not used to melt the plate. There is therefore some of this laser power that is transmitted through the plate, which is greater the smaller the thickness of the plate, the higher the laser power and the lower the welding speed.

Moreover, the laser/arc hybrid welding process is a welding process that combines electric arc welding with laser welding.

Such a laser/arc hybrid process is described in particular in documents EP-A-800 434, EP-A-1 273 383, EP-A-1 199 128, EP-A-1 212 165, EP-A-1 133 375, WO-A-03/11516, WO-A-03/43776. WO-A-03/82511, EP-A-1 160 048, EP-A-1 160 046, EP-A-1 160 047 and EP-A-1 380 380.

The principle of this process is to generate an electric arc between a consumable electrode and a non-consumable electrode and the workpiece or workpieces to be welded, and in concomitantly focusing a power laser beam, of the YAG or CO₂ type for example, in the arc zone. This process, although it also allows very high welding speeds and very large penetration depths to be achieved, thanks to the appearance of a vapour capillary, furthermore makes it possible for the tolerances on the positioning of the workpieces before welding to be considerably increased compared with the very precise positioning essential in laser welding alone, owing to the small size of the focal spot that is used in the latter process.

One problem that exists in laser welding and in laser/arc hybrid welding using a CO₂-type laser generator is the creation of a plasma of shielding gas.

This is because the metal vapour plasma present in the capillary, which is inherent in the laser welding alone, and which is enhanced in hybrid welding by the presence of an electric arc, seeding the shielding gas with free electrons, may initiate the appearance of a shielding gas plasma that is prejudicial to the welding operation.

The laser beam may then be highly, or even completely, absorbed and therefore result in a substantial reduction in the penetration depth, or even in a loss of coupling between the beam and the material and hence a momentary interruption in the welding process.

The threshold at which this shielding gas plasma appears depends on the shielding gas used and on the laser beam power and focusing parameters.

To remedy this problem, gas mixtures that can be used in welding with a CO₂-type laser or in hybrid welding have been proposed in documents EP-A-1 404 482, WO-A-03/57389, EP-A-1 371 444, EP-A-1 371 445, EP-A-1 371 446 and EP-A-1 375 054, which make it possible to guard against the appearance of this shielding gas plasma on the topside.

Moreover, another problem in laser or laser/arc hybrid welding is the shape of the weld bead generally obtained.

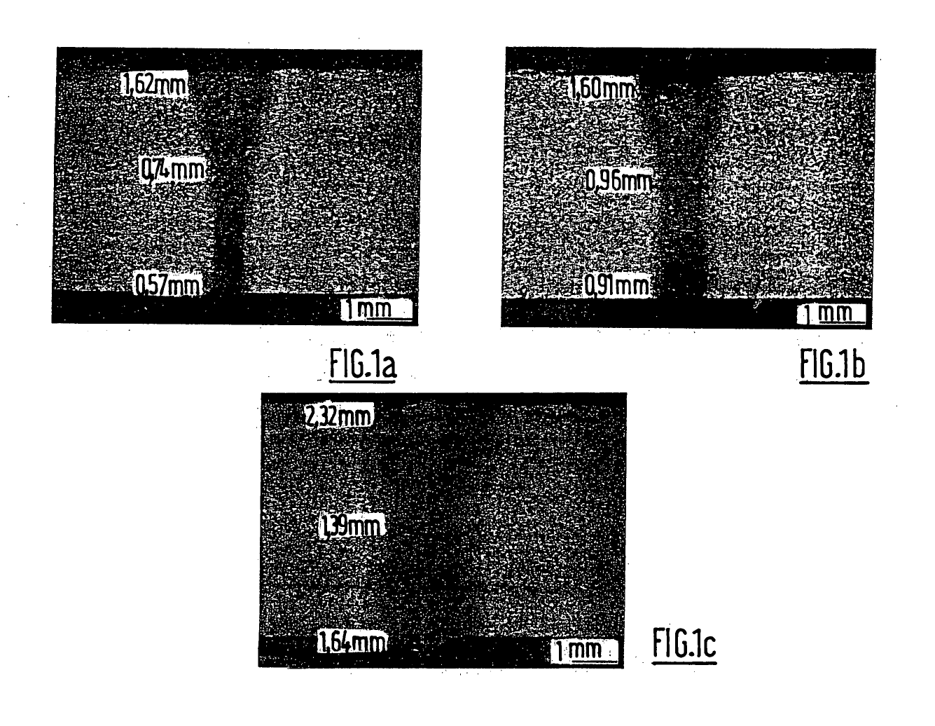

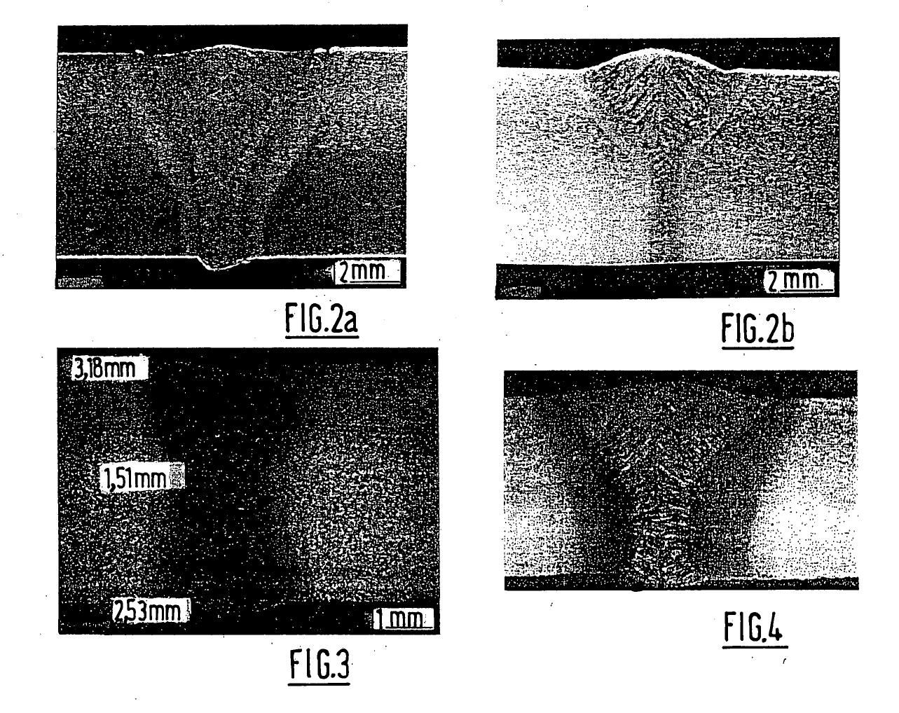

This is because these beads generally have narrow bead roots, which constitutes a major difficulty as it is quite difficult to guarantee that the joint will be correctly welded insofar as the slightest inaccuracy in positioning the laser beam relative to the joint will result in a welding defect. This is illustrated in FIGS. 1 and 2 appended hereto.

It follows that this bead root narrowness problem therefore considerably limits the use of laser welding or hybrid welding in industrial manufacturing processes, in particular when it is necessary to weld workpieces of intermediate thickness, that is to say typically of at least 1 to 2 mm.

The present invention therefore aims to solve this problem by proposing a laser or laser/arc hybrid welding process for obtaining weld beads having wider bead roots than conventional beads and, if necessary, for introducing, into the weld bead, elements that may favour the creation of metallurgical microstructures having good properties, such as oxygen or nitrogen, depending on the case.

The solution of the invention is therefore a CO₂-type laser welding process for joining together one or more metal workpieces by welding, in which:
a) a first shielding gas is used on the topside of the workpiece or workpieces to be welded;
b) a second shielding gas is used on the backside of the workpiece or workpieces to be welded, the said second shielding gas being a gas of different composition from that of the first shielding gas;
c) a full-penetration welded joint is produced via a keyhole obtained by means of the laser beam delivered from the topside of the workpiece or workpieces; and
d) during step c) a plasma is created on the backside in the second shielding gas using at least some of the power transmitted through the keyhole of step c) in order to cause the said plasma to appear in the shielding gas on the backside, the said plasma on the backside contributing to the production of the said welded joint.

Depending on the case, the process of the invention may include one or more of the following features:
steps a) and b) are carried out simultaneously or concomitantly;
during step c) a keyhole is created on the backside of the workpiece or workpieces by means of the laser beam delivered from the topside of the workpiece or workpieces;
the first shielding gas is chosen from helium, argon and argon/helium, helium/nitrogen, helium/oxygen, helium/CO₂, helium/argon/oxygen, helium/argon/CO₂, argon/hydrogen and helium/hydrogen mixtures;
the second shielding gas is chosen from Ar, Ar/O₂, Ar/CO₂, CO₂, CO₂/N₂, O₂, He/O₂, He/CO₂, Ar/N₂, He/N₂ and N₂;
in step (c), an electric arc is also used and the welded joint is produced between the workpiece or workpieces to be welded by means of at least the electric arc and the laser beam that are delivered, by combining one with the other on the topside of the workpiece or workpieces;
the workpiece or workpieces are made of metallic materials, such as carbon steel, manganese carbon steel, microalloyed steel, austenitic stainless steel, ferritic stainless steel, martensitic stainless steel and aluminium alloys, and/or the workpiece or workpieces are flat plates or a tube;
the workpiece or workpieces to be welded have a thickness of at least 1 mm and preferably at least 2 mm;
it is chosen from hybrid laser/TIG or laser/MIG processes;
the welded joint obtained in step d) has a width on the backside of at least 2 mm.

Within the context of the invention:
the term “CO₂-type laser beam” is understood to mean a laser beam generated by a CO₂-type laser generator;
the term “topside” is understood to mean that side of the workpiece or workpieces to be welded located directly facing the laser or hybrid laser welding head, which side first receives the impact of the beam and/or the arc, that is to say the side corresponding to the upper surface of the plate or plates to be welded;
the term “backside” is understood to mean the opposite side of the workpiece or workpieces from the topside, that is to say the side corresponding to the lower surface of the plate or plates to be welded; and
the term “keyhole” is understood to mean the capillary formed from metal vapours and metal vapour plasma, allowing the energy of the laser beam to be directly deposited in the core of the plate to be welded, which is created by the high power density of the laser.

In other words, according to the present invention, the power transmitted (and therefore usually lost in the prior processes) through the keyhole is judiciously used to cause the appearance of a plasma in a suitable shielding gas on the backside, that is to say beneath the plates, this gas being different from the shielding gas on the topside, that is to say above the plate, and thus to deliver, beneath the workpieces to be welded, surplus energy for increasing the width of the bead on the backside.

The invention will be more clearly understood in light of the following explanations given with reference to the appended figures in which:

FIG. 1a shows a welding macrograph for welding with a CO₂-type laser beam with a power of 10.4 kW according to the prior art, steel workpieces 5 mm in thickness, with a welding speed of 7 mm/min, with helium as gas on the topside and with the laser being focused onto the surface of the workpieces to be welded;

FIG. 1b shows a macrograph obtained under the same conditions as those of FIG. 1a but with a welding speed of 3.5 m/min;

FIG. 1c shows a macrograph obtained under the same conditions as those of FIG. 1a, but with a welding speed of 2.5 mm/min and with the laser being focused 5 mm above the surface of the workpieces and with helium as gas on the topside and also on the backside;

FIGS. 2a and 2b show macrographs for laser/arc hybrid welding with an MIG-type arc and a CO₂-type laser beam with a power of 8 kW according to the prior art, for welding steel workpieces 8 mm in thickness with a welding speed of 2.1 m/min (FIG. 2a) and 3 m/min (FIG. 2b) and with an Ar/He/O₂(27%/70%/3%) gas mixture used as shielding gas on both the backside and the topside;

FIG. 3 shows a macrograph for welding with a CO₂-type laser beam with a power of 10.4 kW according to the invention, for welding steel workpieces 5 mm in thickness with a welding speed of 2.5 m/min and with the laser being focused 5 mm above the surface of the workpieces to be welded, and with helium on the topside and argon on the backside; and

FIG. 4 shows a welding macrograph for laser/arc hybrid welding with MIG-type arc and CO₂-type laser beam with a power of 8 kW according to the invention, for welding steel workpieces 8 mm in thickness with a welding speed of 2.1 m/min and with an He/Ar/O₂ mixture on the topside and argon on the backside.

The laser welding macrographs of FIGS. 1a to 1c according to the prior art show that the width on the backside of the weld bead is relatively narrow, that is to say less than 1 mm, and that it is relatively little affected by the welding speed.

Thus, by reducing the welding speed from 7 m/min (FIG. 1a) to 3.5 m/min (FIG. 1b), it may be seen that the width on the backside of the bead goes from 0.6 mm to 0.9 mm, but it remains small however.

By defocusing the laser beam relative to the surface and by further reducing the speed, the width on the backside can be increased slightly, thus reaching 1.6 mm (FIG. 1c), while also slightly increasing the width on the topside of the bead obtained.

This deduction in speed also results in an increase in laser power lost on the backside of the plate. This is because the power not used to melt the plate is transmitted through the keyhole and emerges on the other side, where it is lost in the toothing for fastening or supporting the plates to be joined together. Thus, in general, the more the welding speed is reduced the greater the transmitted power.

FIGS. 2a and 2b show macrographs for laser/MIG hybrid welding according to the prior art. More precisely, FIG. 2a is an example of the hybrid welding of workpieces placed end to end with a spacing of 0.6 mm between them, while FIG. 2b is an example of hybrid welding of workpieces with a bevel having a 3 mm heel and a cone angle of 12°. In both cases, a 70S-type solid wire is used with a wire speed of 15 m/min and the gas mixture on the topside is a mixture formed from 70% He and 27% Ar by volume, the rest (i.e. 3%) being oxygen.

These two macrographs show one of the benefits of hybrid welding, whereby the bead on the topside is increased in width thanks to the presence of an electric arc, thus allowing greater mating or positioning tolerances.

Unfortunately, here again the bead roots are relatively narrow and are not significantly improved compared with laser welding since the macrographs of FIGS. 2a and 2b show a bead width on the backside of only 1.6 mm and 0.8 mm, respectively.

In order for this bead width on the backside to be substantially increased, it would be necessary to drastically reduce the welding speed, thus resulting in a loss of productivity. As in the case of laser welding, the reduction in hybrid welding speed results in an increase in the laser power transmitted through the keyhole.

Based on these observations, the authors of the present invention have the idea of using the transmitted (and therefore usually lost) power through the keyhole to cause plasma to appear in a suitable shielding gas delivered on the backside and different from the shielding gas used on the topside, and thus to deliver, beneath the plate to be welded, surplus energy for increasing the width on the backside of the weld.

Thus, FIG. 3 shows a laser welding bead macrograph for which a plasma has been created, according to the invention, on the backside in the argon used as backside shielding gas, whereas helium is used as gas on the topside.

As may be seen, the backside width of the bead obtained is then 2.5 mm and is to be compared with that of FIG. 1c, which was only 1.6 mm.

Moreover, FIG. 4 shows a macrograph of an inventive laser/MIG hybrid welding bead for which a plasma was created on the backside in argon.

As may be seen, the backside width of the bead in FIG. 4 is 2.6 mm and is to be compared with that of FIG. 2a, which is only 1.6 mm.

In general, the magnitude of the bead root broadening depends, of course, on the quantity of backside argon plasma initiated, this applying both in laser welding and in laser/arc hybrid welding.

Another advantage of the process of the invention is that, depending on the nature of the shielding gas chosen for the backside, it is possible to promote or control the ingress of elements into the weld bead and thus to change the metallurgical microstructure of the weld bead.

Thus, with a gas or gas mixture on the backside such as Ar/O₂, Ar/CO₂, CO₂, O₂, He/O₂ or He/CO₂, when the shielding gas plasma on the backside is created, the oxygen or CO₂ is dissociated and it is thus possible to introduce O₂ molecules into the molten metal.

Moreover, with a gas or gas mixture such as Ar/N₂, He/N₂ or N₂ on the backside, when the shielding gas plasma on the backside is created, nitrogen is dissociated and it is thus possible to introduce nitrogen into the molten metal, which may be useful when welding, for example, steels of the duplex or superduplex type.

1-10. (canceled)

11. A method which may be used for welding with a CO₂ laser, said method comprising:
a) shielding a top portion of at least one work piece with a first shielding gas;
b) shielding a bottom portion of said work piece with a second shielding gas, wherein the composition of said second shielding gas is different from the composition of said first shielding gas; and
c) producing a full penetration weld joint on said work piece, wherein:
1) said joint is produced by a keyhole;
2) said keyhole is produced by a laser beam means delivered to said top portion of said work piece;
3) said keyhole transmits power from said top portion to said bottom portion to create a plasma in said second shielding gas; and
4) said plasma contributes to the production of said weld joint.

12. The method of claim 11, wherein said laser beam means comprises a CO₂ type laser.

13. The method of claim 11, further comprising shielding said top portion and said bottom portion at substantially the same time.

14. The method of claim 11, wherein said work piece is made from at least one material selected from the group consisting of:
a) carbon steel;
b) carbon-manganese steel;
c) a mircoalloy steel;
d) austentic steel;
e) ferritic stainless steel;
f) martensitic stainless steel; and
g) an aluminum alloy.

15. The method of claim 11, wherein said first shielding gas comprises at least one member selected from the group consisting of:
a) helium;
b) argon;
c) an argon/helium mixture;
d) a helium/nitrogen mixture;
e) a helium/oxygen mixture;
f) a helium/carbon dioxide mixture;
g) a helium/argon/oxygen mixture;
h) a helium/argon/carbon dioxide mixture;
i) an argon/hydrogen mixture; and
j) a helium/hydrogen mixture.

16. The method of claim 11, wherein said second shielding gas comprises at least one member selected from the group consisting of:
a) argon;
b) an argon/oxygen mixture;
c) an argon/carbon dioxide mixture;
d) carbon dioxide;
e) a carbon dioxide/nitrogen dioxide mixture;
f) a helium/oxygen mixture;
g) a helium/carbon dioxide mixture;
h) an argon/nitrogen mixture;
i) a helium/nitrogen mixture; and
k) nitrogen.

17. The method of claim 11, wherein:
a) said full penetration weld joint is produced with an electric arc operating in conjunction with said laser beam means; and
b) said electric arc is also delivered to said top portion of said work piece.

18. The method of claim 11, wherein said work piece comprises at least one member selected from the group consisting of:
a) a work piece made of a metallic material;
b) a flat plate;
c) a tube; and
d) a pipe.

19. The method of claim 11, wherein said work piece has a thickness of at least about 1 mm.

20. The method of claim 19, wherein said thickness is at least about 2 mm.

21. The method of claim 17, wherein said electric arc operating in conjunction with said laser beam comprises at least one member selected from the group consisting of:
a) a hybrid laser/TIG welding means; and
b) a hybrid laser/MIG welding means.

22. The method of claim 11, wherein said weld joint has a width, on said bottom portion, of at least about 2 mm.
